(19) United States
(12) Patent Application Publication
(10) Pub. No.: US 2019/0033444 A1
(43) Pub. Date: Jan. 31, 2019

(54) DEVICE FOR MONITORING THE POSITION OF AN OBJECT BY MEANS OF SOUND WAVES

(71) Applicant: ELESTA GmbH, Ostfildern (DE), Branch Office Bad Ragaz, Bad Ragaz (CH)

(72) Inventor: Roman Steiner, Ernetschwil (CH)

(21) Appl. No.: 15/992,036

(22) Filed: May 29, 2018

(30) Foreign Application Priority Data
May 29, 2017 (CH) 00700/17

(51) Int. Cl. G01S 15/08; G01S 7/52; G01S 7/521

(52) U.S. Cl. CPC G01S 15/08; G01S 7/521; G01S 7/52003

(57) ABSTRACT

A device for monitoring the local orientation or position of an object by sound waves, with a sensor part positioned at a distance from the object with at least one sound wave emitter, at least one sound wave receiver, and a computing unit. The computing unit controls the at sound wave emitter and the sound wave receiver and determines the distance between the sensor part and the object, based on the echoes of a sound wave emitted by the sound wave emitter in the direction of the object. An identification reflector separate from the sensor part comprises a three-dimensional pattern. The sensor part has an array of sound wave receivers and sound wave emitters, wherein for identifying the identification reflector and for measuring the distance between the sensor part and the identification reflector, a plurality of echoes between different emitter/receiver-combinations is evaluated.

### CROSS-REFERENCE TO RELATED APPLICATION

This application claims priority to Swiss Patent Application No. 00700/17 filed May 29, 2017, the entirety of which is incorporated by this reference.

### FIELD OF THE INVENTION

The present invention refers to a device and method for monitoring the position of an object and a distance of the object from a sound wave emitter by using sound waves.

### STATE OF THE ART

In the field of security automation, positions of doors or of other movable parts, which have to be monitored in a contactless way, are often monitored by means of magnetic or radio-path-switches. Optical systems may also be used.

Sound waves-based systems, in particular those using an ultrasound technology, are successfully used in a very wide range of applications. A wide spectrum of distance measurements, positioning devices, devices for medical examinations, or installations for scanning welding seams are used.

The present invention refers more in particular to the field of scanning and identifying fingerprints or of detecting welding seams in the metal processing industry.

### ADVANTAGES OF THE INVENTION

An advantage of the invention is thus to provide a device for monitoring the location or position of an object by sound waves, which reliably operates even in an environment with strong electromagnetic interference or also dusty and dirty industrial environments. A further advantage is to provide a device which may be manufactured in a cost-effective way.

### SUMMARY OF THE INVENTION

According to the invention, above stated advantages are achieved by a device and method for monitoring the position of an object and a distance of the object from a sound wave emitter by using sound waves.

The invention refers to a device for monitoring the position of an object as well as its distance from a sound wave emitter using sound waves, with a sensor part, which is positioned at a distance from the object, with

at least one sound wave emitter,

at least one sound wave receiver, and

a computing unit, which is connected with the at least one sound wave emitter and the at least one sound wave receiver, for controlling the same, and which is adapted to determine, based on the echo of a sound wave emitted by the sound wave emitter in the direction of the object, the distance between the sensor part and the object.

According to the invention, the device comprises an identification reflector, which is separate from the sensor part and may be positioned on the object, that is provided with a three-dimensional pattern.

The sensor part has an array of a plurality of sound wave receivers and sound wave emitters, wherein in order to identify the identification reflector and to measure the distance between the sensor part and the identification reflector, a plurality of echoes between different sound wave emitter/sound wave receiver combinations are evaluated.

The inventive device has the considerable advantage that by using an identification reflector, erroneous measurements may factually be avoided, since interfering influences are excluded. The identification reflector operates like an individual key: if the identification pattern is recognized, then the measurement result is valid. In particular in case of a number m of sound wave emitters and a number n of sound wave receivers, m×n combinations of sound wave emitter/receiver-pairs are defined, which provide m×n measurement values. The echoes of different sound wave emitter/receiver-pairs are recorded after the triggering of the sound wave depending on the traveled path after different time lengths by the sound wave receiver. From this information, the pattern of the identification reflector may be computationally reconstructed and compared to a pattern, which is stored in the computing unit. If the recorded deviations are below a certain threshold, then no object is present between the identification reflector and the monitoring device.

An array composed of a plurality of sound wave receivers and sound wave emitters may be comprised, within the scope of the present invention, of a sound wave emitter and a plurality of sound wave receivers or of a sound wave receiver and a plurality of sound wave emitters. However, the array is formed by a plurality of sound wave receivers and an even larger number of sound wave emitters, which is a multiple, in particular two to twenty times the number of sound wave receivers. However, according to another embodiment, the number of sound wave emitters and sound wave receivers is at least 50, more than 100 and or more than 200, wherein the ratio of sound wave emitters to sound wave receivers is between 30:1 and 1:30, between 10:1 and 1:10 or between 5:1 and 1:5.

The identification reflector advantageously has a three-dimensional pattern or relief. An identification reflector having a three-dimensional pattern may be manufactured in a cost-effective way and prevents erroneous measurements. Since the identification reflectors may be provided with different three-dimensional patterns, respectively, the manufacturing by using a 3D printer is of particular utility.

The computing unit is adapted to activate, in a time sequence, different combinations of sound wave emitter/sound wave receiver-pairs and evaluate the corresponding echoes. Since the echoes of different sound wave emitter/sound wave receiver-pairs are recorded at different instants in time, the pattern of the identification reflector may be reconstructed.

The three-dimensional pattern advantageously comprises a plurality of discrete geometric forms spaced from each other, having different cross-sections and/or heights. Such a pattern may be recognized very reliably if an array of sound wave emitters and/or sound wave receivers is used in combination with the identification pattern.

Advantageously, the geometric forms are placed on a support or ground and may comprise at least two, three, or even more parallelepiped-shaped bodies, which are positioned at a distance from each other. The number of geometric forms may be however at least four or more than five.

The one or more sound wave emitters and the one or more sound wave receivers may be placed according to a defined arrangement to each other. The sound wave emitters and sound wave receivers are advantageously positioned according to a matrix, at the center of which the sound wave emitter is positioned, while the sound wave receivers are grouped around the emitter. However also the inverted arrangement is possible, wherein the sound wave receiver is placed at the center and the sound wave emitters are arranged around the same. The sound wave emitters and the sound wave receiver may be positioned on a common circuit board.

The computing unit may be adapted to activate, in a temporally offset way, different combinations of emitter/receiver pairs.

According to one embodiment, the number of possible sound wave emitter/sound wave receiver combinations is respectively larger than 5, larger than 8, or larger than 12. The larger the number of sound wave emitter/sound wave receiver combinations, the higher the resolution of the monitoring device.

Fundamentally, the sound wave receivers and the sound wave emitters may be substantially arranged in the same plane or in different planes. In the second case, the sound wave receivers may be positioned, for example—as viewed in the direction of the identification reflector—behind the sound wave emitters.

Advantageously, the distance between the sensor part and the object is between 0.5 mm and 100 m, between 1 mm and 50 m or between 10 mm and 10 m. Thus, depending on the type and size of the monitoring device, small to large distances may be monitored.

The identification reflector is advantageously mounted within a sound-proof, waterproof enclosure. This is advantageous since it can also be used in industrial environments.

The object to be monitored is in particular a movable part, such as a door, a protective cover, a movable security fence, or self-driving/remotely controlled objects.

According to one embodiment, the computing unit is adapted for activating in a time sequence the sound wave emitters, in order to univocally associate the reflected sound wave to a certain emitter. The device thus operates in such a way that a successive emitter is activated only when the sound wave reflected by the identification reflector is recorded. However, it is fundamentally conceivable, that a successive second emitter is already activated, before the reflected sound wave of the first emitter has been recorded. However, due to the minimal possible distance of the identification reflector it has to be ensured that the recorded sound wave still originates from the previous emitter.

The present invention also provides a method for monitoring the orientation or position of an object by using sound waves, in which a sound wave emitter emits sound waves and a sound wave receiver detects the sound waves reflected by the object, in order to deduce, for example, based on the echo, the presence or absence of the object and/or to measure the distance between the sensor part and the object.

The inventive method is characterized in that an identification reflector is arranged on the object to be monitored, and

for identifying the identification reflector and for measuring the distance between the sound wave emitter and the identification reflector, a plurality of echoes between different emitter/receiver-pairs is evaluated. This method is advantageous in that, on one hand, the reflector may be composed of a plurality of possible combinations, and on the other hand, it may be precisely identified, since the identification reflector reflects a precisely determined echo pattern.

A further advantage of this method is that, contrary to radio-path detecting or optical systems, it may operate, without any problem, also in an environment with strong electromagnetic interferences, which are caused, for example, by welding robots, or in case of influence from external light sources, since it cannot be influenced by electromagnetic radiation and external light. Due to the sound-permeable and waterproof and dust-proof enclosure, the present method may also be used in a dusty and highly polluted industrial environment, since, on one hand, it operates up to a certain pollution level and, on the other hand, the closed surface may also be easily cleaned.

According to another embodiment of the method, the identification reflector is a three-dimensional pattern having two or more discrete geometric forms. This is advantageous in that interferences and disturbing noises may essentially be completely eliminated.

The sound wave emitters and sound wave receivers are advantageously positioned according to a defined array and the echo of different sound wave emitter/sound wave receiver combinations is recorded. This is advantageous in that, in this way, the identification reflector may be identified.

It is conceivable that the sound wave emitter operates according to the piezoelectric effect and that it may emit and receive ultrasound. Each sound wave emitter is controlled, in this case, by an adjustable phase shifter, which slightly delays the signal for the single radiator. By overlapping the sound beam, a summation signal is formed, whose radiation direction may be electronically oriented. By line-by-line scanning, a three-dimensional image may thus be computed.

### BRIEF DESCRIPTION OF THE DRAWINGS

Exemplary embodiments of the invention are now described in further detail with reference to the following figures. In particular:

FIG. 1 schematically shows an exemplary embodiment of the invention with a device for monitoring the position of an object with a sensor part and an identification reflector;

FIG. 2 schematically shows a first exemplary embodiment of the sensor part of FIG. 1 with a control part and an array of sound wave receivers and a single sound wave emitter;

FIG. 3 schematically shows a first exemplary embodiment of the sensor part of FIG. 1 with a control part and an array of sound wave emitters and a single sound wave receiver;

FIG. 4 schematically shows a third exemplary embodiment of a circular array of three sound wave receivers and 37 sound wave emitters; FIG. 1 without enclosure;

FIG. 5 schematically shows a fourth exemplary embodiment of an array of one sound wave receiver and 36 sound wave emitters in a hexagon;

FIG. 6 schematically shows a fifth exemplary embodiment of an array of a respective equal number of sound wave receivers and sound wave emitters, wherein sound wave emitters and sound wave receivers are respectively positioned in a plane and in a staggered succession;

FIG. 7 schematically shows an exemplary embodiment of the identification reflector of FIG. 1 without an enclosure;

FIG. 8 shows the identification reflector of FIG. 7 with an enclosure, which is partially cut out for clarity;

FIG. 9 shows an illustrative example of the invention with a line-by-line arrangement of four sound wave emitters and one simple identification reflector provided at a distance from the emitter array for explaining the phased-array technology;

FIG. 10 shows the shortest paths of sound waves of the example of FIG. 9;

FIG. 11 illustratively shows the inventive evaluation method based on the echo reflected by an identification reflector; and

FIG. 12 shows an inventive device for monitoring a double door with an emitter part and two sound wave receivers.

### DETAILED DESCRIPTION OF THE INVENTION

FIG. 1 schematically shows an example of an inventive device 11 for monitoring the location or position of an object by using sound waves. The device 11 comprises a computing unit 13 and an array 15 of sound wave emitters 17 and sound wave receivers 19. The computing unit 13 is connected with the individual sound wave emitters 17 and sound wave receivers 19 and may selectively control the same and evaluate the signals recorded by the sound wave receivers 19. The computing unit 13 is provided with an output 21, through which a signal, such as an alarm, may be output. The inventive device 11 also comprises an identification reflector 23, which is positioned at a distance from the sensor part 13 and on an object 25 to be monitored (see FIG. 7). In operation, the sound wave emitters 17 emit sound waves 27, which are partially reflected by the identification reflector 23 and recorded by the sound wave receivers 19.

Based on the travel time of sound waves 27, it is possible to precisely calculate the distance between emitter 17 and identification reflector 25 with a given medium and corresponding temporal resolution. If the distance between the sensor part 23 and the identification reflector 23 is changed, a signal may be output by output 21.

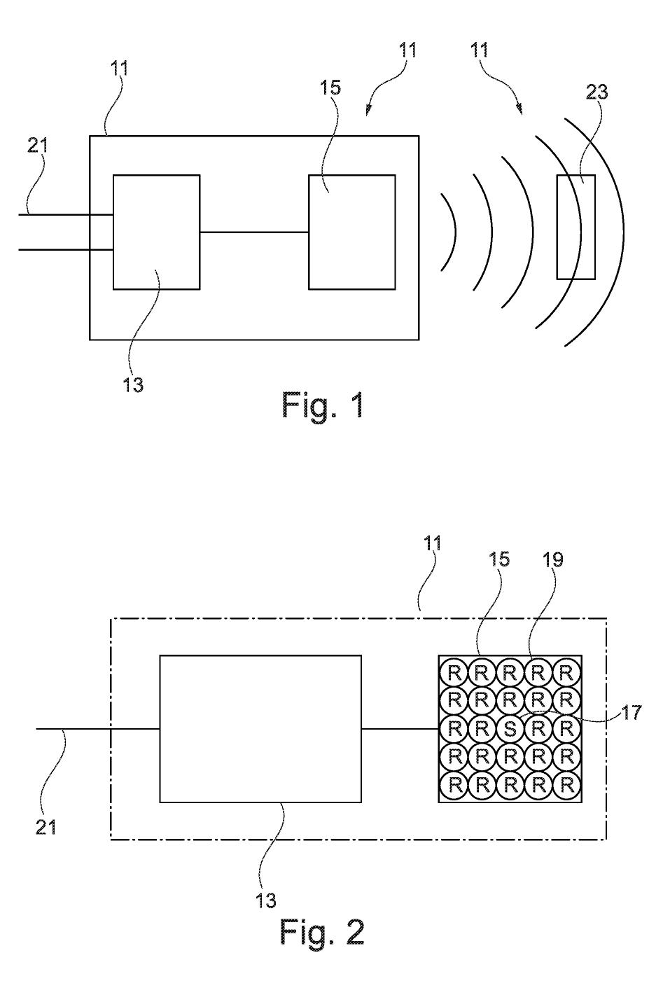

As illustratively shown in FIGS. 2 to 6, both the ratio between sound wave emitters and sound wave receivers and their mutual geometric arrangement may be different. It is however to be noted that the resolution of the inventive device is higher and more precise, the larger the number of sound wave emitters and sound wave receivers used.

The example of FIG. 2 is characterized in that only a single sound wave emitter 17 and a plurality of sound wave receivers 19 are used. The sound wave emitter 17 and the sound wave receivers 19 in the example shown are placed according to a matrix, wherein the only emitter 17 is positioned at the center of the 5×5 matrix array.

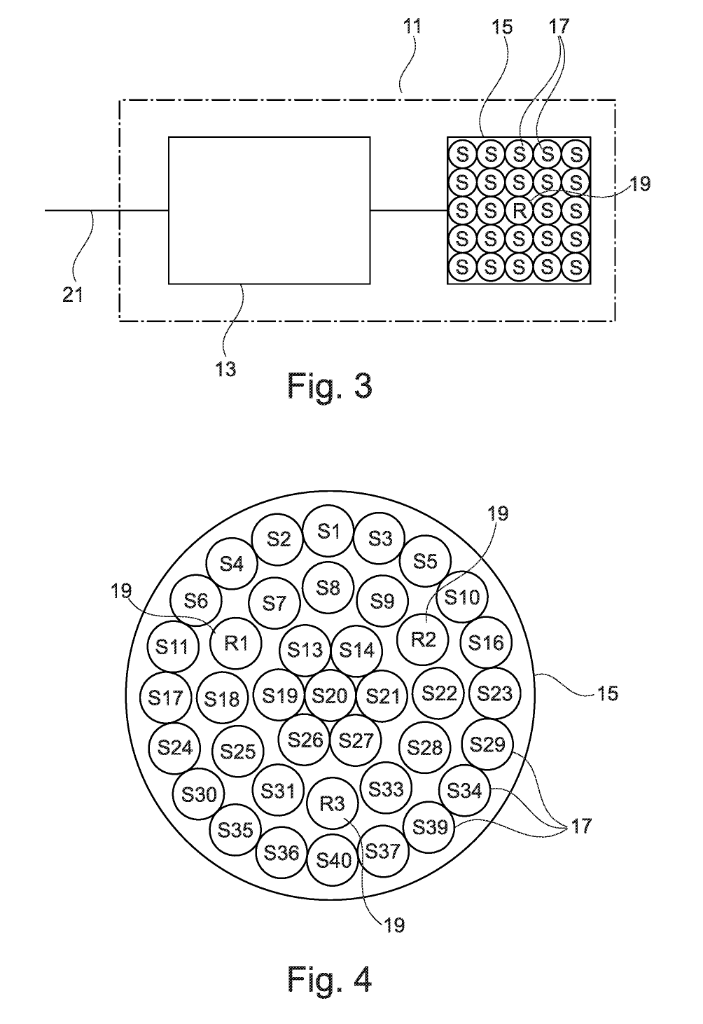

The exemplary embodiment of FIG. 3 differs from the one of FIG. 2 in that a single sound wave receiver 19 and a plurality of sound wave emitters 17 are provided. The receiver 19 is at the center of the array and the sound wave emitters 17 are grouped around the receiver 19.

In the example of FIG. 4, the sound wave emitters 17 and sound wave receivers 19 are arranged on three circles around a central sound wave emitter S20. Three sound wave receivers R1 to R3 on the middle circle form the corner points of an imaginary equilateral triangle. A plurality of sound wave emitters is in a circular arrangement.

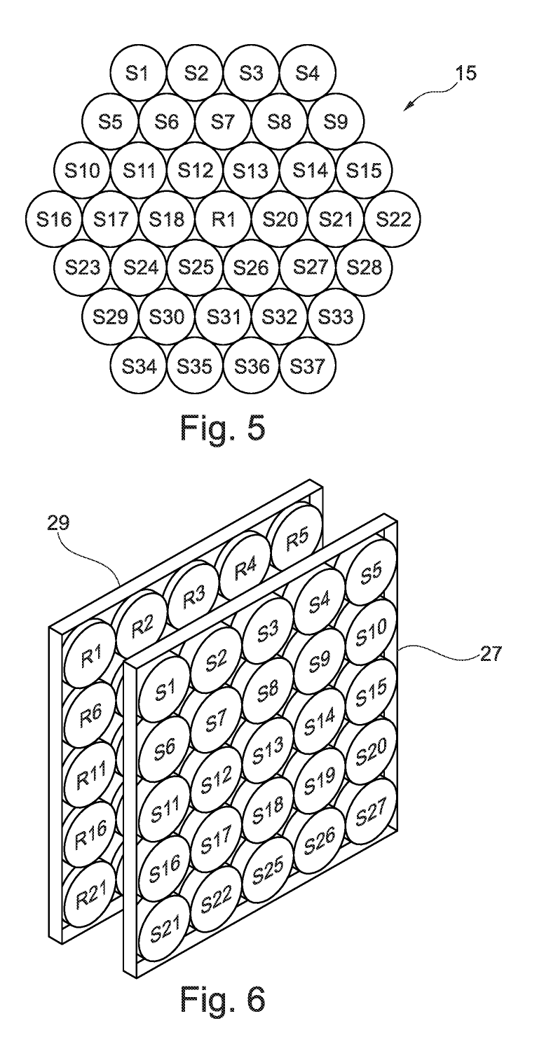

In the example of FIG. 5, the sound wave emitters S1 to S37 are arranged according to a hexagon, wherein at the center of the hexagon the sound wave receiver R1 is positioned.

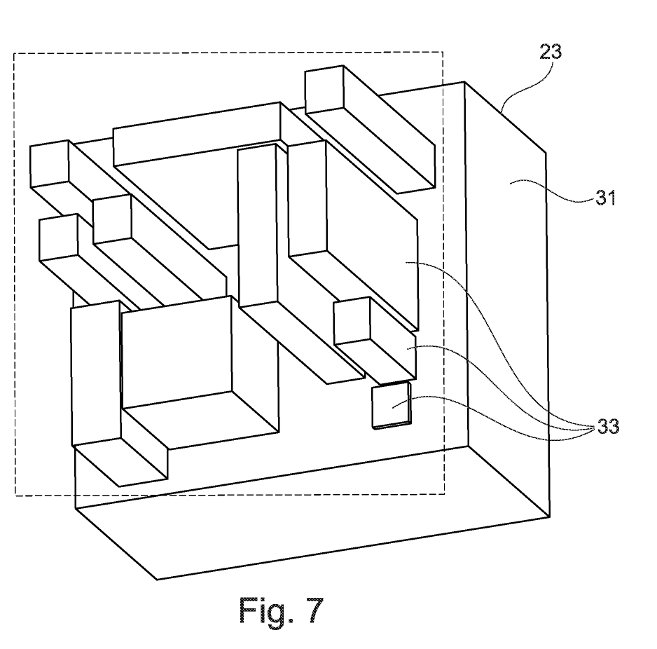

In the example of FIG. 6, the number of sound wave emitters used and the number of sound wave receivers used is the same, wherein the sound wave emitters S1 to S27 are positioned in a first location 27 and the sound wave receivers R1 to R27 are positioned in a second location 29 behind the sound wave emitters. However, it may also be conceived that sound wave emitters and sound wave receivers are alternatingly and adjacently positioned in the same location.

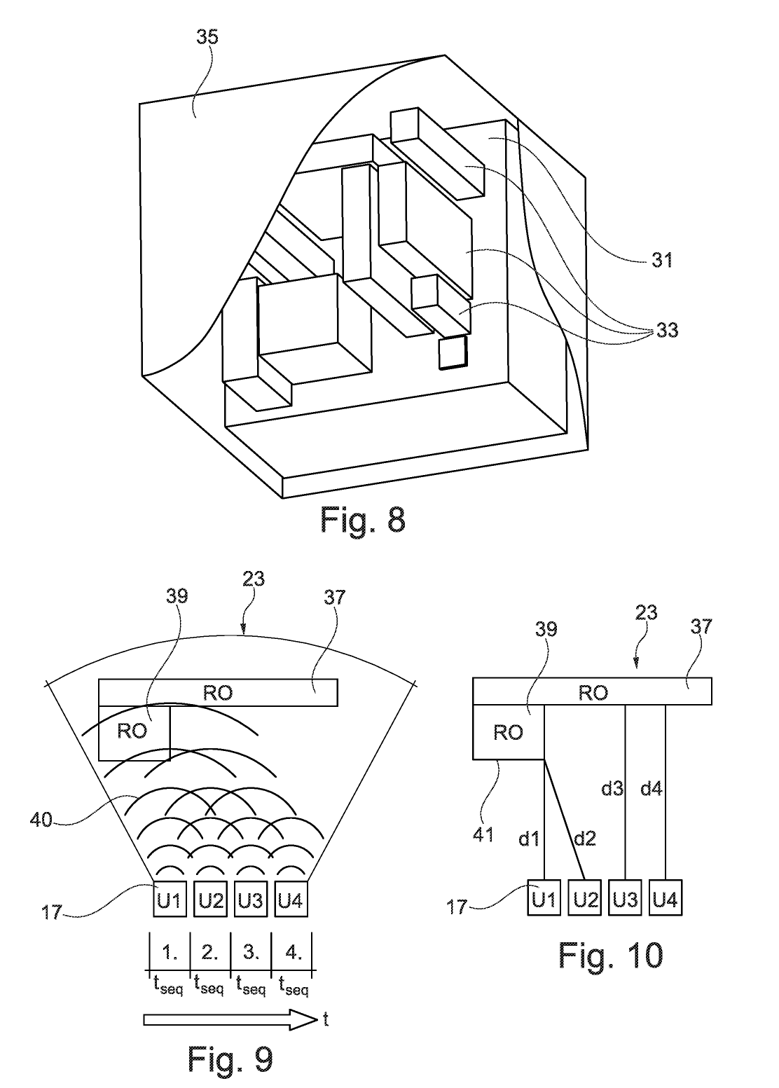

In FIG. 7 an identification reflector 23 is shown in greater detail. The identification reflector 23 has a support 31, on which a plurality of geometric bodies or forms 33 are positioned at a distance from each other. At least individual geometric forms 33 have a different height and a different cross-section. According to the example shown, the geometric forms are parallelepipeds, which are positioned on the support 31. The identification reflector 23 may comprise an enclosure 35, which is at least partially transparent to sound waves (FIG. 8). This allows the use of the inventive device also in polluted environments or installations, which have to be washed.

FIG. 9 shows, as an explanation of the measurement concept, an array of four sound wave emitters U1 to U4 and one identification reflector 23, which is at a distance from the sound wave emitters. The identification reflector 23 is formed by a flat reflector part 37 and a parallelepiped 39, positioned on the left side of the reflector part, which protrudes beyond the reflector part 37 in the direction of the sound wave emitters U1 to U4. The sound wave emitters U1 to U4 are activated, in a time sequence, after a time period t_{seq} and emit sound waves 40. As shown in FIG. 10, d₁ is the shortest distance between the emitter U₁ and the anterior front face 41 of parallelepiped, d₂ is the shortest distance between the emitter U₂ and the anterior front face 41 of parallelepiped, and d₃ or d₄ are the respective shortest distances between emitters U₃ and U₄ and the reflector part 37.

Those skilled in the art will recognize that with a corresponding high number of temporally successive echo measurements between different pairs of sound wave emitters and sound wave receivers, the spatial structure of the identification reflector may be resolved, so that a unique association to a certain reflector part is possible. It is also conceivable that the sound waves are additionally modulated for delimitation with respect to other possible interfering noises.

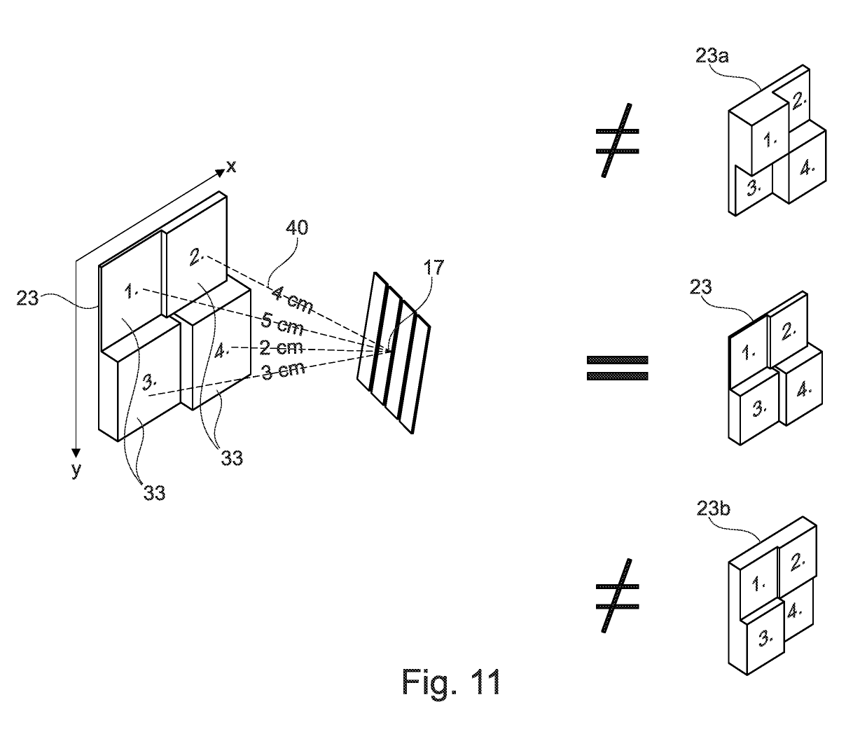

In FIG. 11 a simple example is shown, where the paths of the sound waves emitted by a single emitter differ from each other, according to which form 33 of the reflector part has reflected the sound wave 27. Thus, the distance of the sound wave emitter 17 from the form having the number 1 and position coordinates (X1, Y1) is 5 cm, from form having number 2 and position coordinates (X2, Y1) 4 cm, from form having number 3 and position coordinates (X1, Y2) 3 cm and from form having number 4 and position coordinates (X2, Y2) 2 cm. In the following table 1, the different distances between the sound wave emitter 17 and the identification reflector 23 are summarized:

| Array | X position 1 | X position 2 |
|---|---|---|
| Y position 1 | 5 cm | 4 cm |
| Y position 2 | 3 cm | 2 cm |

In contrast, the distances between an identification reflector 23a, as shown in the upper side on the right, would be as follows:

| Array | X position 1 | X position 2 |
|---|---|---|
| Y position 1 | 3 cm | 5 cm |
| Y position 2 | 5 cm | 3 cm |

The corresponding distances between an identification reflector 23b, as shown in the lower part on the right, would be as follows:

| Array | X position 1 | X position 2 |
|---|---|---|
| Y position 1 | 4 cm | 3 cm |
| Y position 2 | 2 cm | 5 cm |

Since the measured distances only correspond with the central identification reflector 23 shown on the right side, whose pattern is stored in the memory of the computing unit, the identification reflector 23 is thus univocally identifiable.

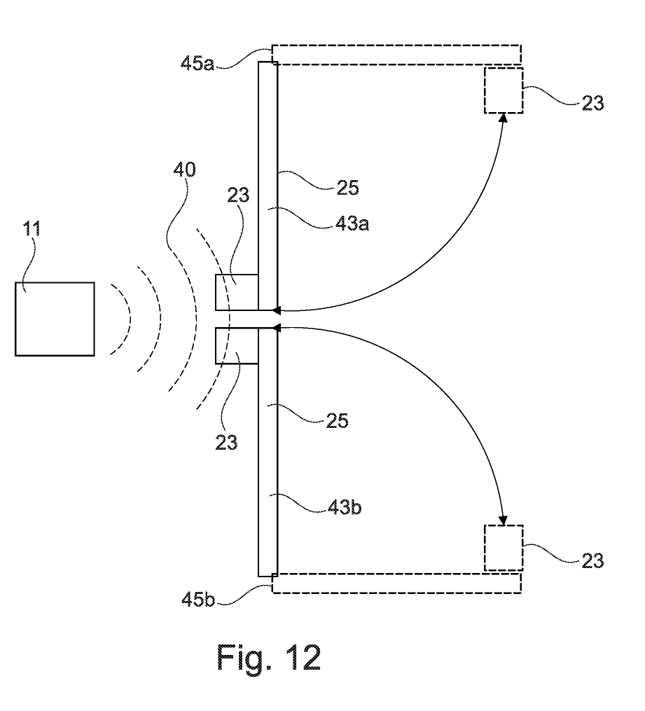

FIG. 12 shows how the inventive device may be used for monitoring an object 25, in this case a double door made of two door wings 43a, 43b, which may be rotated around swing axes 45a, 45b. In this case, a sensor part 11 forms, together with two sound wave receivers 23, a monitoring device for both wings 43a, 43b of the double door. The open position of the door wings is shown by a dashed line in FIG. 12.

The inventive method may be implemented by any of the arrays of sound wave emitters and sound wave receivers shown in FIGS. 2 to 6. It is only to be noted that the number of sound wave emitters and sound wave receivers and their mutual distances are sufficient, in combination with a certain identification reflector and the distance between the sensor part and the identification reflector, for obtaining the required resolution for a univocal identification of the identification reflector.

Conclusion: Based on the echo of a plurality of different sound wave emitter/sound wave receiver combinations the pattern of the three-dimensional identification reflector is reconstructed.

1. A device for monitoring the position of an object and a distance of the object from a sound wave emitter, by using sound waves, comprising:
a sensor comprising an array of a plurality of sound waive receivers and a plurality of sound wave emitters;
a computing unit connected to and controlling the plurality of sound wave emitters and the plurality of sound wave receivers, the computing unit configured for determining the distance between the sensor and the object, based on a plurality of echoes of a sound waves emitted by the plurality of sound wave emitters in a direction of the object; and
an identification reflector, which is separate from the sensor and which comprises a three-dimensional pattern;
wherein in order to identify the identification reflector and to measure the distance between the sensor and the identification reflector, the plurality of echoes between different combinations of the plurality of sound wave emitters and plurality of sound wave receivers is evaluated.

2. The device of claim 1, wherein the computing unit is configured for activating, in a time sequence, different combinations of sound wave emitter and sound waive receiver pairs comprised of the plurality of sound waive emitters and sound wave receivers and evaluate corresponding echoes of the plurality of echoes.

3. The device of claim 1, wherein the three-dimensional pattern comprises a plurality of discrete geometric forms spaced from each other, which have at least one of different cross-sections or different heights.

4. The device of claim 3, wherein the plurality of geometric forms are arranged on a support.

5. The device of claim 3, wherein the plurality of geometric forms comprise at least two bodies.

6. The device of claim 1, wherein the plurality of sound wave emitters and the plurality of sound wave receivers are positioned relative to each other according to a defined arrangement.

7. The device of claim 1, wherein the plurality of sound wave emitters and the plurality of wave receivers are arranged on a circuit board.

8. The device of claim 2, wherein the computing unit is configured for activating, in a temporally offset way, the different combinations of sound wave emitter and sound waive receiver pairs.

9. The device of claim 1, wherein a number of possible different combinations of the plurality of sound wave emitters and the plurality of sound waive receivers is greater than 5.

10. The device of claim 1, wherein the plurality of sound wave receivers and the plurality of sound wave emitters are arranged in substantially a same plane.

11. The device of claim 1, wherein the plurality of sound wave receivers and the plurality of sound wave emitters are arranged in different planes.

12. The device of claim 1, wherein the distance between the sensor and the object is between 0.5 mm and 100 m.

13. The device of claim 1, wherein the identification reflector is mounted inside a sound-permeable, waterproof enclosure.

14. The device of claim 1, wherein the object to be monitored is a movable device.

15. The device of claim 1, wherein the computing unit is configured for activating the plurality of sound wave emitters in a phase-shifted time sequence.

16. A method for monitoring the location of an object by using sound waves, comprising:
a generating a plurality of sound waves with a plurality of sound wave emitters; and
detecting the plurality of sound waves reflected by an object with a plurality of sound wave receivers in order to measure at least a distance between a sensor and the object based on a plurality of echoes of the sound waves reflected from the object
positioning an identification reflector on the object; and
evaluating the plurality of echoes between different pairs of the plurality of sound wave emitters and the plurality of sound wave receivers to determine at least a distance between the plurality of sound wave emitters and the object.

17. The method of claim 17, further comprising using the identification reflector, wherein the identification reflector comprises a three-dimensional pattern having two or more discrete geometric forms.

18. The method of claim 17 further comprising recording echoes of different combinations of the plurality of sound wave emitters and the plurality of sound wave receivers, the plurality of sound wave emitters and the plurality of sound wave receivers positioned according to a defined arrangement to each other.

19. The method of claim 17, further comprising, evaluating echoes of different combinations of the plurality of sound wave emitters and the plurality of sound wave receivers in a time sequence.

20. The method of claim 19, further comprising reconstructing the three-dimensional pattern of the identification reflector based on the echoes of the different combinations of the plurality of sound wave emitters and the plurality of sound wave receivers.

21. The method of claim 20, further comprising, comparing the reconstructed pattern of the identification reflector to one or more stored reference patterns.

22. The method of claim 21 further comprising activating an alarm or switching an output of the sensor if a difference between the reconstructed pattern of the identification reflector and the one or more stored reference patterns is detected.

23. The method of claim 16, further comprising modulating the emitted sound waves with an additional signal to perform a noise suppression.

24. The method of claim 16, wherein when the identification reflector is positively detected, processes are validated or performed, comprising at least one of a detection of an empty material stack drawer or a safe identification of a certain automatic material supply within a technical production process.

25. The method of claim 16, further comprising detecting objects or persons within a “protection area” between the identification reflector and the sensor.

26. The method of claim 1, wherein the sensor comprises a door contact switch of a safety door for protecting an automatically operating technical installation.
